(19) United States
(12) Patent Application Publication
(10) Pub. No.: US 2022/0372953 A1
(43) Pub. Date: Nov. 24, 2022

(54) METHOD FOR CONTROLLING A WIND POWER INSTALLATION, WIND POWER INSTALLATION, AND WIND FARM

(71) Applicant: Wobben Properties GmbH, Aurich (DE)

(72) Inventor: Enno von Aswege, Großefehn (DE)

(21) Appl. No.: 17/747,619

(22) Filed: May 18, 2022

(30) Foreign Application Priority Data
May 19, 2021 (EP) 21174699.5

(51) Int. Cl. F03D 7/02; F03D 7/04

(52) U.S. Cl. CPC F03D 7/0276; F03D 7/022; F03D 7/048; F05B 2270/101

(57) ABSTRACT

Provided is a method for controlling a wind power installation, an associated closed-loop controller, an associated installation and a wind farm. The installation has an aerodynamic rotor which is operated at a variable rotating speed and has rotor blades that have adjustable blade angles. The installation in at least one operating range is closed-loop controlled by a closed-loop rotating speed control in which the rotating speed by adjusting a rotor status variable of the rotor blades is closed-loop controlled to a rotating speed target value, referred to as the target rotating speed. The closed-loop rotating speed control for adjusting the rotor status variable includes the use of a reserve value. In the event that the installation is not yet operating at a target output or a target moment, the reserve is obtained from a comparison of the target output or target moment and a momentary output or a momentary moment.

### BACKGROUND

### Technical Field

The present disclosure relates to a method for controlling a wind power installation, to an associated wind power installation, and to an associated wind farm.

### Description of the Related Art

Wind power installations are known; they obtain electric power from wind. To this end, said wind power installations usually have a rotor having rotor blades which are moved by the wind. The rotor thereupon rotates at a rotor rotating speed and drives a generator, the rotor rotating speed also depending on the wind speed.

In order to control this power generation, the rotor blades can be adjusted in terms of the pitch angle thereof, this also being referred to as pitching. Moreover, the power output, or a generator moment of the generator, respectively, can be influenced in order to control the wind power installation. This also results in a variable rotor rotating speed and thus a variable generator rotating speed. In the case of a gearless wind power installation the rotor rotating speed corresponds to the generator rotating speed.

The control of the wind power installation has in particular the task of guaranteeing at low rotating speeds an operation ideally optimized for output, said operation generating as much output as possible. At high wind speeds the wind power installation is to be controlled such that any rotating speed limitation and any output limitation are adhered to without excessive loads acting on the wind power installation.

At minor wind speeds the operation can also be referred to as a partial-load operation or partial-load operating range, and at high wind speeds as a full-load operation or full-load operating range, respectively. As much output as possible is thus to be generated in the partial-load operation, and in the full-load operation the wind power installation is to be controlled such that the latter is protected against overload. Corresponding control concepts are known. Accordingly, a characteristic curve control in which an operation characteristic curve predefines a correlation between the rotating speed and the output to be adjusted therefor is usually used for the partial-load operation. The blade angle herein is constant in most instances. A closed-loop rotating speed control which by way of adjusting the rotor blades attempts to keep the output as well as the rotating speed constant is in most instances used in the full-load operation.

Further special considerations can be added to these basic requirements. It is thus an increasingly frequent occurrence that a change in an output target value is required by a grid operator, the wind power installation having to quickly respond to said change. Moreover, there are further sensitivities in terms of the closed-loop control, in particular the closed-loop rotating speed control, as a result of which brief slumps in the wind lead to revenue losses.

### BRIEF SUMMARY

Provided is an improved closed-loop rotating speed control of a wind power installation, a method for controlling a wind power installation and an associated wind power installation.

Proposed in one aspect is a method for controlling a wind power installation. The wind power installation has an aerodynamic rotor which is operated at a variable rotating speed and which has rotor blades that are adjustable in terms of the blade angles thereof. The wind power installation in at least one operating range is closed-loop controlled by a closed-loop rotating speed control in which the rotating speed by adjusting a rotor status variable of the rotor blades is closed-loop controlled to a rotating speed target value, referred to as the target rotating speed.

The closed-loop rotating speed control for adjusting the rotor status variable includes the use of a reserve value. The reserve value, in the event that the wind power installation is not yet operating at a target output, or a target moment, respectively, is obtained from a comparison of the target output or the target moment of the wind power installation and a momentary output or a momentary moment of the wind power installation.

Accordingly, the method offers an upgrade for a known closed-loop controller structure in which the closed-loop rotating speed control takes place by adjusting the rotor status variable as the actuating variable. In that the reserve value is utilized for correcting the actuating variable, or the control error thereof, respectively, larger amplitudes of the actuating variable are made possible, specifically always when there is a sufficient reserve. For example, the reserve value can be understood to be a measure of how much additional output the wind power installation could extract from the wind without reaching output or load barriers.

The inclusion of the reserve value can be implemented at any arbitrary point of the closed-loop rotating speed control. For example, when the closed-loop rotating speed control contains a proportional controller and/or a derivative controller, the reserve value for influencing the closed-loop control can be implemented before or after the individual control elements. In the case of parallel control passages, even only one of the control passages can be influenced by the reserve value.

It is only decisive that the rotor status variable ultimately adjusted in the context of the closed-loop rotating speed control demonstrates a dependence on the reserve value. Accordingly, a difference between the rotor state variables to be adjusted will be able to be appreciated in the case of dissimilar reserve values. The exact implementation and internal integration of the reserve value in known closed-loop rotating speed controls will be carried out according to the knowledge of those skilled in the art.

For example, the rotor status variable can be a pitch angle or else a pitch rate, wherein other rotor status variables such as deflection angles of aerodynamic add-on components, for example flaps, or else twisting of the rotor blade per se, and similar, are conceivable.

Advantageously, a generator moment, or a generator output, respectively, of the generator is not simultaneously adapted, because the generator moment, or the generator output, respectively, as the momentary output, or the momentary moment, respectively, finds its way into the determination of the reserve value.

The momentary output is preferably either an actual output such as, for example, an air gap output of the generator, an output at the transformer, or an intervening output value. This actual output can be determined by one or a plurality of output sensors. However, the momentary output can also contain a current target value of the corresponding output, said target value being used as the target value for the control of the output. It is decisive that the momentary output has the same reference point as the target output.

As opposed to an actual output, the error scenario in which the reserve output is permanently achieved in the event of a closed-loop output control error in the generator cannot arise when a target value of the closed-loop output control is used.

The description presently and in the further course of the present disclosure is predominantly explained while using outputs. In an analogous manner, a corresponding moment can be used instead of outputs, without this being explicitly explained in each case. The design embodiments described in the context of outputs can thus also be implemented in a likewise manner, and while achieving the same advantages, using corresponding moments.

The closed-loop rotating speed control preferably takes place such that a first control error of the rotor is determined from a comparison of a predefined target rotating speed and a detected actual rotating speed, the first control error is corrected using the reserve value so as to obtain a second control error, and a pitch angle or a pitch rate as a target value for adjusting the rotor status variable is determined from the second control error.

In this preferred design embodiment the reserve value is thus included prior to determining a target value for the adjustment of the rotor status variable, while the reserve value in other embodiments is also included first in order for the determined target value to be corrected, for example.

By virtue of the rotor inertia, inter alia, it is a challenge to utilize a closed-loop rotating speed control for rapidly introducing output variations. In that the closed-loop rotating speed control error, referred to as the first control error, is corrected using this reserve value, the resultant second control error can assume a higher value than the actual deviation between the target rotating speed and the actual rotating speed. This, for example, larger second control error accordingly can enable a faster introduction of output variations, because the rotor status variable is adjusted by, for example, a higher value than indicated by the actual closed-loop rotating speed control error.

Preferably, the target output, or the target moment, respectively, is determined as the lowest value of the following values:
a maximum output, or a maximum moment, respectively, of the wind power installation,
a maximum output, or a maximum moment, respectively, which is permitted by the output limitation of the grid, and
a maximum output, or a maximum moment, respectively, from a special operation of the wind power installation, in particular from a generator drying operation and/or a closed-loop controlled storm operation.

A maximum output, or a maximum moment, respectively, here is provided in particular by virtue of load limits such as structural load limits of the generator, for example, of the aerodynamics, of the loads, etc. Said maximum output, or maximum moment, respectively, in certain circumstances may also be above a nominal output of the wind power installation, for example at cold temperatures, when even a generator output that is higher than the nominal output can be implemented without damaging the generator.

In other cases however, the maximum output, or the maximum moment, respectively, can also be determined by the nominal output of the wind power installation.

At least one, preferably a plurality, and particularly preferably all, of the following operations a) to d) are preferably carried out based on the reserve value prior to the latter being included in the closed-loop rotating speed control.
a) Setting the reserve value to zero in the event that a deviation of the target rotating speed from the detected actual rotating speed undershoots a threshold value. As a result, a significant criterion is used for the deviation of the target nominal rotating speed from the actual rotating speed.
b) Setting the reserve value to zero in the event that the reserve value is negative. It can be ensured as a result that—in a manner corresponding to the meaning of the term “reserve”—only positive output or moment reserves are allowed to be included in the further closed-loop control.
c) Scaling, in particular mitigating, the reserve value according to a filter function. Using this operation, the effect of high reserve values can be diminished, this being advantageous for load reasons, for example.
d) Delimiting the reserve value to a maximum reserve value. This operation can also be advantageous for load reasons, because excessively high reserve values are prevented.

The first control error, prior to the correction using the reserve value, by means of at least one control error limit value is preferably restricted to a permissible range of control errors.

The limitation here is advantageous at a lower limit, i.e., in terms of decelerating the rotor, as well as at an upper limit, thus in terms of accelerating the rotor. This takes place in particular for load considerations.

Higher values of the control error outside the permissible range are possible after the correction using the reserve value. Accordingly, the second control error can lie thereabove, this being provided as permissible for the first control error.

The at least one control error limit value is preferably adjustable and/or an upper and a lower control error limit value having dissimilar values are provided as the at least one control error limit value.

The first control error is preferably determined so as to be based on a rotating speed variation, a rotating speed acceleration, a function of the rotating speed variation and/or a function or the rotating speed acceleration.

The rotating speed as a control variable is relatively sluggish. It has been demonstrated that closed-loop controlling of the rotating speed based on a rotating speed variation, a rotating speed acceleration, or a function thereof, enables more effective and rapid closed-loop controlling of the rotating speed.

The closed-loop rotating speed control preferably has an outer cascade, containing a first closed-loop controller, and an inner cascade, containing a second closed-loop controller, wherein the second closed-loop controller contains in particular a control error as a reference variable that has been corrected using the reserve value.

The control error of the second closed-loop controller preferably comprises an acceleration target value of the rotor.

The first control error preferably comprises a first acceleration target value, and the second control error comprises a second acceleration target value, and the second acceleration target value is compared with an acceleration actual value of the rotor so as to determine a pitch angle or a pitch rate as the target value for the adjustment of the rotor status variable.

The first acceleration target value, the second acceleration target value and the acceleration actual value are in each case preferably configured as an acceleration output and/or an acceleration moment, wherein the acceleration output is assigned to a rotor acceleration and describes an output that is required to initiate the rotor acceleration, and/or the acceleration moment is assigned to a rotor acceleration and describes a moment that is required to initiate the rotor acceleration.

The inner cascade, in particular the second closed-loop controller, for determining a, or the, actuating variable for adjusting the rotor status variable preferably has an integral element having an integrator delimitation.

The integrator delimitation is preferably adjustable and/or the integrator delimitation has dissimilar upper and lower limit values.

A feedback signal to the second closed-loop controller preferably comprises an aerodynamic output received by the rotor, wherein the aerodynamic output received by the rotor comprises a sum of a rotor acceleration output and at least one output received by a further component of the wind power installation, in particular a generator output of a generator of the wind power installation, wherein the rotor acceleration output describes that part of an output received by the rotor of the wind power installation that is converted into an acceleration of the rotor.

The method furthermore preferably comprises a) determining an aerodynamic tower vibratory output, or an aerodynamic tower vibratory moment, respectively, and b) correcting the rotor acceleration output while using the aerodynamic tower vibratory output, or the aerodynamic tower vibratory moment, respectively.

By taking into account the aerodynamic tower vibratory output, the actual aerodynamic acceleration output that can be traced back to the wind is obtained, as a result of which the closed-loop rotating speed control can be further improved.

The determination of the aerodynamic tower vibratory output, or the aerodynamic tower vibratory moment, respectively, preferably comprises:
determining an absolute wind speed in the region of the wind power installation;
determining a net wind output on the rotor based on the absolute wind speed;
determining an apparent wind output, or an apparent wind moment, respectively, on the rotor based on the speed of the tower head and/or of the nacelle;
determining the aerodynamic tower vibratory output, or the aerodynamic tower vibratory moment, respectively, based on a difference between the apparent wind output and the net wind output.

In that the aerodynamic tower vibratory output is determined from the apparent wind output and the net wind output, the wind power installation can be controlled more precisely and more rapidly. In particular, the disturbance variable for the closed-loop control can thereby be decoupled, this consequently leading to the closed-loop control, in particular the closed-loop rotating speed control of the wind power installation, not exciting the tower vibrations in the first place. Accordingly, the typically required damping of the tower vibrations loses importance already because the tower vibrations are not excited in the first place.

The speed of the tower head, or of the nacelle, respectively, can be estimated, determined or measured in a known, suitable manner. In this way, acceleration sensors can be integrated in the nacelle, or the tower head, respectively, or strain gauges may even be provided at arbitrary locations on the tower, for example.

The tower head speed, or the nacelle speed, respectively, preferably comprises the speed component in the axial direction, or the longitudinal direction, respectively, of the nacelle.

The absolute wind speed is preferably determined from an apparent wind speed which is estimated, determined or measured in suitable, known ways. To this end, anemometers or wind estimators which estimate the wind from operating parameters of the wind power installation, in particular from loads and/or outputs, can be utilized, for example.

The absolute wind speed is accordingly obtained in that the apparent wind speed is compensated by the speed at which the reference system, in particular the tower head of the wind power installation, moves.

Thereupon, an apparent wind output on the rotor is determined based on the speed of the tower head and/or of the nacelle as well as the absolute wind speed.

The absolute wind speed is preferably not influenced by the speed of the tower head and corresponds to a wind speed determined in the region of the wind power installation minus the speed of the tower head and/or of the nacelle of the wind power installation.

The output, or the moment, respectively, of the rotor is preferably corrected by the aerodynamic tower vibratory output or the tower vibratory moment, respectively, multiplied by a factor, wherein the multiplication factor is between 0.5 and 5, preferably between 1 and 4.

An optimally decoupled disturbance variable is achieved at a multiplication factor of 1; the power of vibration is actively damped at a value above 1.

The closed-loop rotating speed control is preferably configured to control the wind power installation in at least one predefinable rotating speed range of the partial-load operating range and/or in a transition range from the partial-load operating range to the full-load operating range to the rotating speed target value by way of superimposing a closed-loop rotating speed output control and a closed-loop pitch control, wherein the rotating speed in the case of the closed-loop pitch control is closed-loop controlled to the rotating speed target value by adjusting the rotor status variable, in particular a pitch angle, and wherein the rotating speed in the case of the closed-loop rotating speed output control is closed-loop controlled by adjusting a generator status variable to be adjusted, in particular a generator output or a generator moment.

The transition range in the partial-load operating range preferably lies in an upper rotating speed range that is characterized by rotating speeds exceeding a transitional rotating speed, wherein the upper rotating speed range lies in particular above a rotating speed avoidance range, wherein the wind power installation is characterized by a nominal rotating speed, and the transitional rotating speed is at least 80%, in particular at least 85%, of the nominal rotating speed and/or a target rotating speed of the closed-loop pitch control.

For the closed-loop rotating speed output control the rotating speed target value is preferably predefined by way of a transitional rotating speed characteristic curve which forms the, or a, rotating speed characteristic curve, wherein for a rotating speed having a rotating speed value corresponding to the transitional rotating speed the transitional rotating speed characteristic curve runs vertically so that the rotating speed is constant as the generator status variable increases until the generator status variable reaches a predetermined first generator reference value which lies below a nominal value of the generator status variable, and/or the transitional rotating speed characteristic curve as from the transitional rotating speed and/or as from the first generator reference value has a positive gradient so that the values of the generator status variable increase as the rotating speed increases until a nominal value of the generator status variable is reached.

The second control error is preferably transmitted from the closed-loop rotating speed output control to the closed-loop pitch control, and the closed-loop rotating speed output control and the closed-loop pitch control operate at least partially in parallel and are mutually adapted by way of the second control error, and/or wherein a switchover or a transition between the closed-loop rotating speed output control and the closed-loop pitch control takes place as a function of the second control error.

The closed-loop rotating speed output control is preferably prioritized in relation to the closed-loop pitch control, in particular such that the closed-loop pitch control is completely or partially suppressed as long as the closed-loop rotating speed output control does not reach an actuating variable limitation, and/or the closed-loop pitch control additionally controls the rotating speed as a function of an acceleration actual value of the rotor, and control of the rotating speed by the closed-loop pitch control is increasingly suppressed the more the generator target value in the closed-loop rotating speed output control lies below a generator target value limit.

Proposed in a further aspect is a closed-loop controller structure for a wind power installation, wherein the wind power installation has an aerodynamic rotor which is operated at a variable rotating speed and which has rotor blades which are adjustable in terms of the blade angles thereof, wherein the wind power installation in at least one operating range is closed-loop controlled by a closed-loop rotating speed control in which the rotating speed by adjusting a rotor status variable of the rotor blades is closed-loop controlled to a rotating speed target value, referred to as the target rotating speed. The closed-loop controller structure for adjusting the rotor status variable is configured to include the use of a reserve value, wherein
the reserve value, in the event that the wind power installation is not yet operating at a target output, or a target moment, respectively, is obtained from a comparison of the target output or the target moment of the wind power installation and a momentary output or a momentary moment of the wind power installation.

The closed-loop controller structure can be combined with all of the preferred design embodiments of the described method for controlling a wind power installation. The advantages described in the context of the latter are achieved in an analogous manner here.

The closed-loop controller structure is preferably configured such that
a first control error of the rotor is determined from a comparison of a predefined target rotating speed and a detected actual rotating speed,
the first control error is corrected using the reserve value so as to obtain a second control error, and
a pitch angle or a pitch rate as the target value for adjusting the rotor status variable is determined from the second control error.

Proposed in a further aspect is a wind power installation having a closed-loop controller structure according to the present disclosure.

The closed-loop controller structure for this purpose can have, for example, the same components as a known installation control unit (e.g., controller) of a wind power installation, including a computer unit (e.g., computer) such as a microprocessor and/or a central processing unit (CPU) as well as suitable storage components and interfaces. In this case, the closed-loop controller structure accordingly differs from the known control units of wind power installations in terms of the software stored and/or executed on said closed-loop controller structure. In other embodiments, the implementation of the method can also take place partially or completely by hardware.

In yet further embodiments the control unit, or the closed-loop controller structure, respectively, is split, wherein only part of the control unit is situated in the spatial region of the wind power installation, for example in the nacelle of the wind power installation or within a tower of the wind power installation, and further parts of the control unit are implemented on a spatially remote computer unit. For example, the remote computer unit comprises a server which is connected to the further parts of the control unit by way of the Internet.

Proposed in a further aspect is a wind farm having a plurality of wind power installations according to the disclosure.

The wind farm according to this aspect, as well as the wind power installation according to the previously described aspect, can be combined with all of the preferred design embodiments of the disclosed method, wherein the same advantages are achieved.

### BRIEF DESCRIPTION OF THE SEVERAL VIEWS OF THE DRAWINGS

Further advantages and preferred design embodiments will be described hereunder with reference to the appended figures, in which:

FIG. 1 in a schematic and exemplary manner shows a wind power installation;

FIG. 2 in a schematic and exemplary manner shows a wind farm;

FIG. 3 in a schematic and exemplary manner shows a closed-loop controller structure for closed-loop rotating speed controllers of wind power installations;

FIG. 4 in a schematic and exemplary manner shows a diagram for determining a reserve value;

FIG. 5 in a schematic and exemplary manner shows a further closed-loop controller structure;

FIG. 6 in a schematic and exemplary manner shows a closed-loop controller structure having a correction; and

FIG. 7 in a schematic and exemplary manner shows a wind estimator.

### DETAILED DESCRIPTION

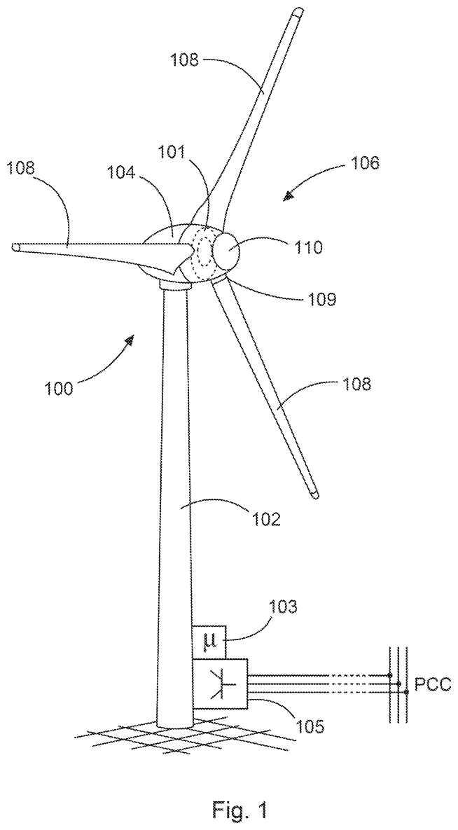

FIG. 1 shows a schematic illustration of a wind power installation according to the invention. The wind power installation 100 has a tower 102 and a nacelle 104 on the tower 102. An aerodynamic rotor 106 having three rotor blades 108 and a spinner 110 is provided on the nacelle 104. During the operation of the wind power installation the aerodynamic rotor 106 is set in a rotating movement by the wind, and thus also rotates an electrodynamic rotor of a generator which is coupled directly or indirectly to the aerodynamic rotor 106. The electric generator is disposed in the nacelle 104 and generates electric power. The pitch angles of the rotor blades 108 can be varied by pitch motors at the rotor blade roots 109 of the respective rotor blades 108.

The wind power installation 100 here has an electric generator 101 which is indicated in the nacelle 104. Electric power can be generated by means of the generator 101. An infeed unit 105 is provided for feeding in electric power, said infeed unit 105 being able to be configured in particular as an inverter. In this way, a three-phase infeed current and/or a three-phase infeed voltage according to amplitude, frequency and phase can be generated for feeding in at a grid connection point PCC. This can take place directly or else conjointly with further wind power installations in a wind farm. An installation control unit (e.g., installation controller) 103 is provided for controlling the wind power installation 100 and also the infeed unit 105. The installation control unit 103 may also receive parameters from outside, in particular from a central farm computer.

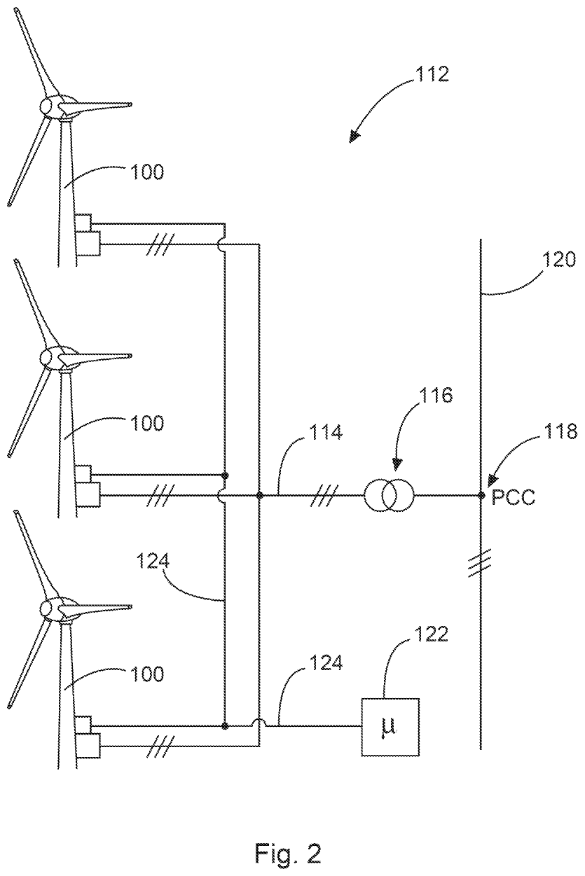

FIG. 2 shows a wind farm 112 having, in an exemplary manner, three wind power installations 100 which may be identical or dissimilar. The three wind power installations 100 are thus representative of a fundamentally arbitrary number of wind power installations of a wind farm 112. The wind power installations 100 provide the output thereof, specifically in particular the generated current, by way of an electric farm grid 114. The currents or outputs, respectively, generated in each case by the individual wind power installations 100 here are added, and in most instances a transformer 116 is provided which transforms the voltage in the farm so as to then feed the latter into the supply grid 120 at the infeed point 118, which is generally also referred to as the PCC. FIG. 2 is merely a simplified illustration of a wind farm 112. The farm grid 114 can be of a different design, for example, in that a transformer is also provided at the outlet of each wind power installation 100, in order to mention only one other exemplary embodiment.

The wind farm 112 moreover has a central farm computer 122 which may synonymously also be referred to as a central farm control unit (e.g., central farm controller). The latter can be connected to the wind power installations 100 by way of data lines 124, or be wirelessly connected, so as to thereby exchange data with and in particular receive measured values from the wind power installations 100 and to transmit control values to the wind power installations 100.

Closed-loop controller structures for operating wind power installations are known. Said closed-loop controller structures are configured as part of the installation control unit 103, for example. So-called closed-loop pitch-controlled wind power installations in which the rotor blades of the rotor of the wind power installation are adjustable about the longitudinal axis thereof, the so-called pitch axis, are most widely used. An aerodynamic output of the rotor blades is varied by varying the pitch angle, as a result of which it is possible for the output to be restricted to the nominal output when the nominal wind has been reached.

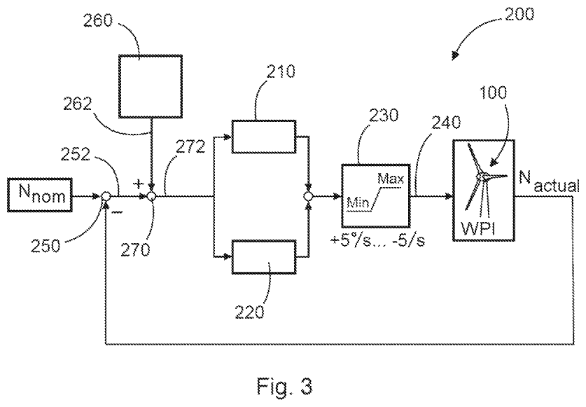

To this end it is known to provide so-called closed-loop rotating speed controllers, as schematically shown in FIG. 3, so as to approximately maintain a target rotating speed Nₙₒₘ. The closed-loop rotating speed controller 200 is configured to ideally adjust the target rotating speed Nₙₒₘ as a reference variable, wherein an actual rotating speed N_{actual} measured by the wind power installation 100 is fed back, and the deviation is converted into a pitch rate to be adjusted, for example by means of a proportional controller 210 and a derivative controller 220. Other control elements than the proportional controller 210 and the derivative controller 220 are also conceivable in other closed-loop controllers. The pitch rate is adjusted to a target pitch rate 240 so as to be delimited by a pitch rate limiter 230, said target pitch rate 240 then being used for operating the wind power installation 100. In this case, the target pitch rate 240 is a target value for adjusting the rotor status variable.

The deviation of the measured actual rotating speed N_{actual} from the target rotating speed Nₙₒₘ is obtained as a result of a differential element 250 and referred to as the first control error 252. As opposed to conventional closed-loop rotating speed controllers, this first control error 252 in an additional element 270 is corrected using a reserve value 262 so that a second control error 272 results.

This second control error 272 is then utilized for determining the target value for adjusting the rotor status variable, in this example the target pitch rate 240.

The reserve value 262 is determined by a reserve value determination unit 260 which can likewise be configured as part of the installation control unit 103, for example. The input interfaces of the reserve value determination unit 260 have been omitted in FIG. 3 for reasons of simplification of the illustration.

The inclusion of the reserve value 262 in the example of FIG. 3 is thus already shown at a very specific point in the closed-loop rotating speed control 200; the reserve value 262 here by means of the additional element 270 is specifically included ahead of the proportional controller 210, or the derivative controller 220, respectively. The description herein is however not limited thereto, and the reserve value 262 can be included at any arbitrary point of the closed-loop rotating speed control 200.

In another example, the inclusion of the reserve value 262 can thus take place merely ahead of or after one of the two control elements, i.e., the proportional controller 210 or the derivative controller 220, respectively. In other embodiments, in the case of a correspondingly conceived reserve value 262, the inclusion of the reserve value 262 can also take place ahead of, or after, the pitch rate limiter 230, thus also directly on the rotor status variable to be adjusted, such as the target pitch rate 240.

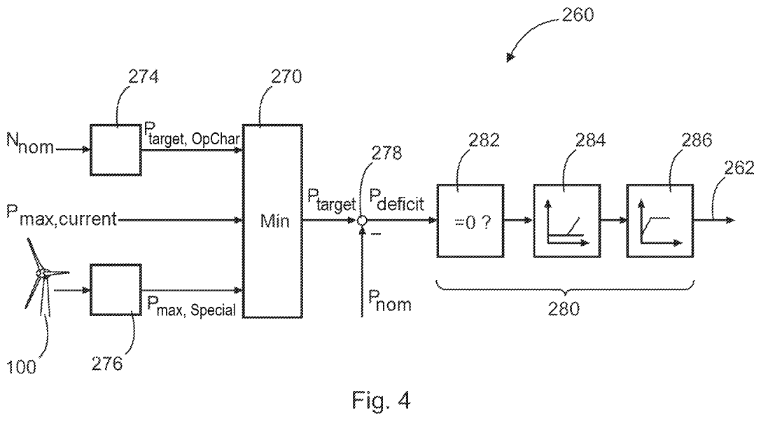

FIG. 4 in a schematic and exemplary manner shows the reserve value determination unit 260 in detail. The reserve value determination unit 260 comprises a target output determination unit 270 and a filter unit 280, and provides the reserve value 262 for correcting the control error to the closed-loop rotating speed control 200, for example.

The target output determination unit 270 determines a target output P_{target} from which a momentary output Pₙₒₘᵢₙₐₗ is subtracted in a step 278. A non-filtered reserve output, referred to as P_{deficit} is obtained as a result. The monetary output is either an actual output such as, for example, an air gap output of the generator, an output at the transformer, or an intervening output value, or an actual target value of the closed-loop output control. It is decisive that the momentary output has the same reference point as the target output.

The target output determination unit 270 determines a target output P_{target}, in this example as the lowest value of three potential target outputs P_{target,OpChar}, P_{max,current} and P_{max,Special}.

A first target output P_{target,OpChar} is obtained in a computer unit (e.g., computer, CPU or arithmetic and logic unit, among others) 274, for example from the target rotating speed Nₙₒₘ in an operation characteristic curve, in particular a rotating speed output characteristic curve. It is to be noted here that an actual rotating speed is usually utilized so as to derive an output by means of the operation characteristic curve. It is thus unusual to correlate a target rotating speed Nₙₒₘ with the operation characteristic curve, this however specifically offering the advantage of the obtained target output P_{target,OpChar}. In other embodiments, the first target output P_{target,OpChar} can also be provided by virtue of load limits such as structural load limits of the generator, for example, the aerodynamics, the loads, etc. In certain cases, said target output P_{target,OpChar} may also be above a nominal output of the wind power installation, for example at cold temperatures, when a generator output that is higher than the nominal output can even be implemented without damage to the generator.

A second target output P_{max,current} is a maximum output, or a maximum moment, respectively, which is permitted by an output limitation of the grid. This value can be provided to the wind power installation 100 by a grid operator, for example. In particular with a view to stabilizing the grid, it may be necessary here that the wind power installation 100 be not allowed to generate the maximum potential output which is able to be generated at the prevailing wind conditions.

Finally, a third target output P_{max,Special} is a maximum output, or a maximum moment, respectively, of a special operation of the wind power installation, in particular of a generator drying operation and/or a closed-loop controlled storm operation. It can thus be prevented that the provision of the reserve value 262 impairs the operation during a special operation, or even counteracts the latter.

Optionally, the non-filtered reserve output P_{deficit} is filtered by means of the filter unit (e.g., filter) 280. To this end, the filter unit 280 can contain one, a plurality, or all, of a zero adjuster 282, a mitigator 284 and a limiter 286 in the sequence shown or any other sequence.

The zero adjuster 282 sets the reserve output P_{deficit} to 0 when the reserve output P_{deficit} is less than 0, thus negative, and/or the closed-loop rotating speed control error, thus the deviation between the target rotating speed Nₙₒₘ and the actual rotating speed N_{actual} undershoots a predefined threshold value. The predefined threshold value can be, for example, 0.5 revolutions per minute.

The mitigator 284 implements scaling, in particular mitigating, of the reserve value according to a filter function. Using this operation, the effect of high-value reserve values can be mitigated, this being advantageous for load reasons, for example.

The limiter 286 delimits the reserve value to a maximum reserve value. This operation can also be advantageous for load reasons, because excessively high reserve values are prevented.

In other words, the reserve value 262 of the wind power installation 100, when the latter is not yet operating at the target output, or the target moment, respectively, enables the difference to be utilized as an additional acceleration output so as to accelerate more rapidly. In principle, this could also be explained in that the entire received aerodynamic output of the wind power installation 100 is closed-loop controlled so that this is also referred to as a closed-loop Pₐₑᵣₒ control.

Like the filtered reserve output, the non-filtered reserve output P_{deficit} is an example of a reserve value 262, wherein analog determinations using moments instead of outputs are likewise advantageously possible.

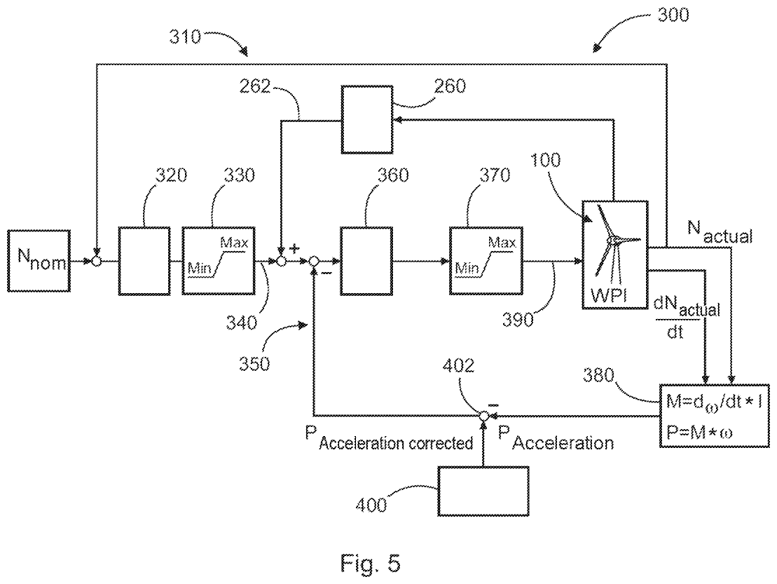

FIG. 5 in a schematic and exemplary manner shows a further closed-loop controller structure 300 for a wind power installation 100 as is shown in FIG. 1, for example. The closed-loop control structure (e.g., closed-loop controller) 300 is configured as a closed-loop cascade control and has an outer closed-loop control circuit 310 and an inner closed-loop control circuit 350. The closed-loop controller structure 300 controls a rotating speed in the wind power installation to a target value Nₙₒₘ. To this end, the outer closed-loop control circuit 310 compares the actual rotating speed N_{actual} with the target rotating speed Nₙₒₘ to be adjusted and by means of a signal of a proportional controller 320 that is delimited by a limiter 330 generates a target value 340 of the rotor acceleration output P_{acc_target}. In this example, the rotor acceleration output P_{acc_target} is a first control error of the rotor which is corrected by means of the reserve value 262, as is described in FIGS. 3 and 4.

The inner closed-loop control circuit 350 now adjusts to the rotor acceleration output P_{acc} and attempts to actuate the rotor blades of the wind power installation 100 in such a manner that the rotor 106 is accelerated as little as possible, or that the rotor 106 accelerates while using the reserve value, respectively. To this end, an actual acceleration output P_{acc} is determined by means of a computer unit (e.g., computer, CPU or arithmetic and logic unit, among others) 380, for example by means of the temporal variation of the rotor rotating speed dN_{actual}/dt.

The difference between the target value 340 of the acceleration output P_{acc_target}, corrected using the reserve value 262, and the determined actual value P_{acc}, by way of a proportional controller 360, for example, is converted into a pitch rate to be adjusted, or a blade angle of the rotor blades 108 to be adjusted, respectively. As has already been explained, the pitch rate, or the blade angle to be adjusted, respectively, are of course only examples of a rotor status variable of the rotor blades.

The pitch rate to be adjusted, or the pitch angle to be adjusted, respectively, can be delimited by a limiter 370, the latter as a target value 390 then being transferred to the control unit of the wind power installation 100.

The computer unit 380 in this example utilizes known physical correlations between the known moment of inertia J for the rotor, a torque M and the rotating speed, or the angular velocity ω derived therefrom, respectively, so as to calculate the actual acceleration output P_{acc} from the variation of the rotating speed.

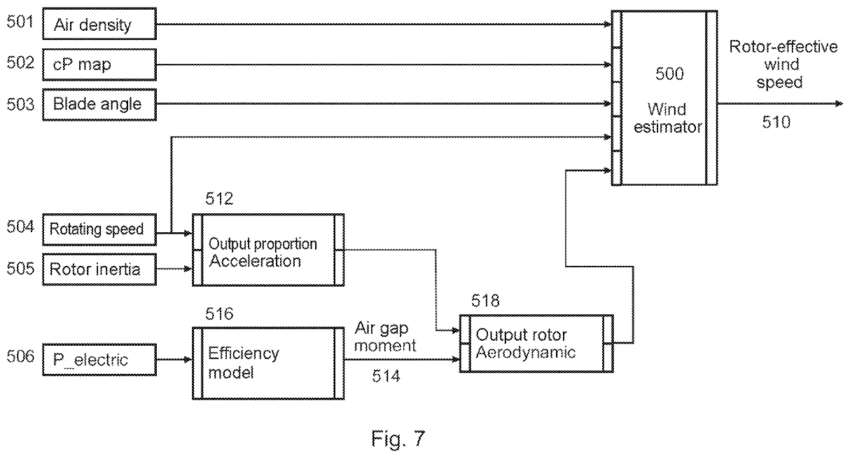

Instead of the rotor acceleration output as is described in the exemplary embodiment, it is also possible to use the entire aerodynamic output received by the rotor, that is to say while additionally taking into account the output received by the generator. One advantage of the rotor acceleration output is in many cases that the variable is often already available for wind estimators used in controlling wind power installations 100, that is to say that no further adaptation of the control of the wind power installation 100 is required. Accordingly, it suffices to merely replace the known closed-loop rotating speed control with a closed-loop controller structure 300. An example of a wind estimator 500 is described with reference to FIG. 7.

As an alternative to the outputs, the closed-loop controller structure 300 set forth in an exemplary manner can also be implemented using moments, or rotating speeds derived over time, respectively. These solutions are identical, with the exception of the aspect that the current rotating speed is also included in the acceleration output. However, the way in which outputs are converted into moments and vice versa is well-known.

The inner closed-loop control circuit 350 per se over time would lead to considerable rotating speed errors such that the outer closed-loop control circuit 310, which responds in a significantly slower and more sluggish manner, generates a target value for the acceleration output that may deviate from 0 kW. For example, if there is an excessive rotating speed situation, that is to say that the actual rotating speed N_{actual} is higher than the target rotating speed Nₙₒₘ, the target value 340 would be −200 kW, for example. In this case, the inner closed-loop control circuit 350 would adjust to an approximate rotor acceleration output P_{acc} of −200 kW so that the rotor 106 reduces the rotating speed as a result.

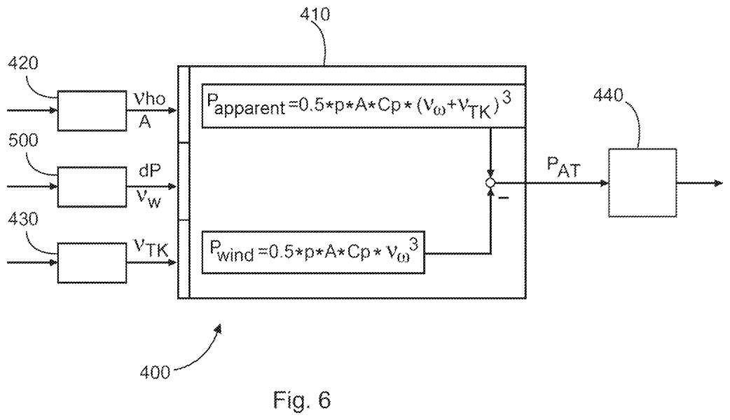

Finally, the acceleration output P_{acc} at a point 402 is corrected by a correction value provided by a correction device 400, so as to obtain a corrected value of the acceleration output P_{acc_corrected}—which can be used in an analogous manner for moments. The correction device 400 will be described with reference to FIG. 6.

The delimitation of the output of the closed-loop rotating speed control by the limiters 330 or 370 enables that the maximum acceleration output is restricted, this likewise having a load-reducing effect.

The closed-loop controller structure 300 schematically shown in FIG. 5 can therefore particularly advantageously be enhanced by a preliminary control unit (e.g., preliminary controller) disposed parallel to the inner closed-loop control circuit 350. The preliminary control unit can control in a preliminary manner with a view to forecast wind gusts, for example, and, in addition to the closed-loop control, accordingly actively intervene in the pitch angle actuation. Extreme loads such as arise as a consequence of heavy wind gusts can thus be avoided in a particularly effective manner.

Summarizing, the closed-loop controller structure 300 is configured to close-loop control the rotating speed to a rotating speed target value Nₙₒₘ. The inner closed-loop control circuit 350 receives the aerodynamic output, or the acceleration output, respectively, received by the rotor 106, or else merely simplifies the rotor acceleration as the control variable, wherein the pitch rate, or alternatively a target rotor blade angle, or other rotor status variables, serves/serve as (an) actuating variable(s). The outer closed-loop control circuit 310 as a control variable controls the rotor rotating speed N, wherein a target value of the aerodynamic output, the acceleration output or else the target rotor acceleration is generated as an actuating variable for the inner closed-loop control circuit 350.

The inclusion of the reserve value 262, also in the example of FIG. 5, is thus already shown at a very specific point in the closed-loop rotating speed control 300. Also with a view to this embodiment of the closed-loop rotating speed control 300, it is explicitly pointed out that the inclusion of the reserve value 262 is not limited to the form shown, and that the reserve value 262, in a manner analogous to the closed-loop rotating speed control 200, can be included at any arbitrary point of the closed-loop rotating speed control 300.

FIG. 6 shows the correction device 400 which integrates a correction value of the acceleration output P_{acc} in the inner closed-loop control circuit 350 of FIG. 5 at a point 402. Accordingly, the result is a correction value 402 of the acceleration output P_{acc}, wherein the method in an analogous manner can likewise be applied to moments.

The correction value 402 in physical terms corresponds to an aerodynamic output which emanates from the vibration of the tower of the wind power installation 100 and is referred to as the aerodynamic tower vibratory output P_{AT}. For this purpose, an apparent wind output Pₐₚₚₐᵣₑₙₜ and a net wind output P_{wind} are calculated by means of a computer unit (e.g., computer, CPU or arithmetic and logic unit, among others) 410, for example by means of the following formulas:

Pₐₚₚₐᵣₑₙₜ=0.5*ρ*A*cₚ*(ν_{w}+ν_{TK})³ (1)

P_{wind}=0.5*ρ*A*cₚ*ν_{w}³ (2)

P_{AT}=Pₐₚₚₐᵣₑₙₜ−P_{wind} (3)

Parameters of the wind power installation, such as an air density ρ and a rotor area A, provided by a parameter unit 420 serve initially as input variables of the computer unit 410. A tower head speed estimation 430 provides the tower head speed ν_{TK}. The latter is determined by way of an acceleration sensor, which is fastened in the tower head or to the nacelle, for example. Other methods for estimating the tower head speed, for example by way of strain gauges, which are disposed on the foot of the tower or in the tower, are also known.

Finally, a wind speed v_{w}, which is not influenced by the tower head speed, is provided by a wind estimator 500. The wind estimator 500 will be described in detail later, with reference to FIG. 7. Other methods for providing a wind speed ν_{w}, for example methods based on anemometers, or similar measuring devices, are also suitable instead of wind estimators 500. The wind speed ν_{w}, provided by the wind estimator 500 is determined either directly, without the influence of the tower head speed or, alternatively, the tower head speed ν_{TK} is subsequently subtracted from the wind speed ν_{w}.

The computer unit 410 then determines the apparent wind output Pₐₚₚₐᵣₑₙₜ from a difference of the wind speed ν_{w}, and the tower head speed ν_{TK}. Additionally, the net wind output P_{wind} is determined exclusively from the wind speed ν_{w}.

The difference between the two outputs by the computer unit 410 is then formed as the aerodynamic tower vibratory output P_{AT}. The aerodynamic tower vibratory output P_{AT} 412 is transferred to a multiplier 440 which, depending on the multiplication factor, enables a P_{AT} compensation (multiplication factor of 1) or a P_{AT} overcompensation (modification factor of more than 1, preferably between 1 and 4). The P_{AT} compensation is a pure interference variable decoupling, while damping of P_{AT} takes place in the P_{AT} overcompensation.

The inner closed-loop control circuit 530 is accordingly supplied, as a control variable, an acceleration output P_{acc_corrected} that has been reduced by the output of the multiplier 440.

The computer unit 410 and the further units 420, 430, 500 can be integrated in the very same computer device as the computer unit 380. For example, a central computer of the wind power installation 100 can assume all of the functions. Alternatively, one, a plurality or all of the functions can be split among a plurality of computer units (e.g., computers). It is likewise possible to carry out the calculations partially or even completely on devices which are disposed so as to be remote from the wind power installation 100. Servers or similar structures may be suitable to this end, for example.

FIG. 7 in a schematic and exemplary manner shows a wind estimator 500. The wind estimator 500 processes different input variables so as to obtain a rotor-effective wind speed 510.

The wind estimator 500 first obtains an air density 501, a cP-map 502 and a currently prevailing blade angle of the rotor blades 503.

A rotating speed 504, a rotor inertia 505 and the electric output 506 are included as further parameters in the wind estimator 500. The rotating speed 504 and the rotor inertia 505 are converted into an output proportion for the acceleration 512 and by way of an air gap moment 514, which has been derived from the electric output 506 by means of an efficiency model 516, combined so as to form the aerodynamic output of the rotor 518.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method for controlling a wind power installation,
wherein the wind power installation includes:
an aerodynamic rotor operable at a variable rotating speed and which has rotor blades that have adjustable blade angles, and
wherein the method comprises:
performing, in at least one operating range of the wind power installation, closed-loop control, the closed-loop control including a closed-loop rotating speed control; and
performing the closed-loop rotating speed control on the rotating speed, the closed-loop rotating speed control including:
in response to the wind power installation not yet operating at a target output or a target moment, obtaining a reserve value based on a comparison of the target output or the target moment of the wind power installation with a momentary output or a momentary moment of the wind power installation, respectively;
adjusting a rotor status variable of the rotor blades based on the reserve value; and
controlling the rotating speed to become a target rotating speed based on adjusting the rotor status variable.

2. The method according to claim 1, wherein the closed-loop rotating speed control includes:
determining a first control error of the rotor based on a comparison of a predefined target rotating speed with a detected actual rotating speed;
correcting the first control error using the reserve value to obtain a second control error; and
determining a pitch angle or a pitch rate for adjusting the rotor status variable from the second control error.

3. The method according to claim 1, wherein the target output or the target moment is determined as a lowest value of:
a maximum output or a maximum moment, respectively, of the wind power installation;
a maximum output or a maximum moment, respectively, that is permitted by an output limitation of a grid; or
a maximum output or a maximum moment, respectively, from a special operation of the wind power installation.

4. The method according to claim 2, comprising:
prior using the reserve value in the closed-loop rotating speed control:
setting the reserve value to zero in response to a difference between the target rotating speed and the detected actual rotating speed being less than a threshold value;
setting the reserve value to zero in response to the reserve value being negative;
scaling the reserve value using a filter; or
limiting the reserve value to a maximum reserve value.

5. The method according to claim 2, comprising:
prior to correcting the first control error using the reserve value, limiting the first control error, using at least one control error limit value, to a permissible range of control errors.

6. The method according to claim 5, wherein the at least one control error limit value is adjustable, and/or an upper and a lower control error limit value having different values are used as the at least one control error limit value.

7. The method according to claim 2, comprising:
determining the first control error based on a rotating speed variation, a rotating speed acceleration, a function of the rotating speed variation and/or a function of the rotating speed acceleration.

8. The method according to claim 1, wherein the closed-loop rotating speed control includes:
an outer cascade that includes a first closed-loop; and
an inner cascade that includes a second closed-loop, wherein the second closed-loop uses, as a reference variable, a control error that is corrected using the reserve value.

9. The method according to claim 8, wherein the control error of the second closed-loop includes an acceleration target value of the rotor.

10. The method according to claim 2, wherein
the first control error includes a first acceleration target value, and the second control error includes a second acceleration target value, and
the second acceleration target value is compared with an acceleration actual value of the rotor to determine a pitch angle or a pitch rate for adjustment of the rotor status variable.

11. The method according to claim 10, wherein
the first acceleration target value, the second acceleration target value and the acceleration actual value are each configured as an acceleration output and/or an acceleration moment, wherein
the acceleration output is assigned to a rotor acceleration and represents an output to be reached to initiate the rotor acceleration, and/or
the acceleration moment is assigned to the rotor acceleration and represents a moment to be reached to initiate the rotor acceleration.

12. The method according to claim 8, comprising:
determining, by the inner cascade an actuating variable for adjusting the rotor status variable, wherein the inner cascade has an integral element having an integrator delimitation, and wherein the integrator delimitation is adjustable and/or has upper and lower limit values that are different.

13. The method according to claim 8, wherein:
a feedback signal to the second closed-loop includes an aerodynamic output received by the rotor
the aerodynamic output received by the rotor includes a sum of a rotor acceleration output and at least one output received by another component of the wind power installation, and
the rotor acceleration output represents a part of the aerodynamic output received by the rotor of the wind power installation that is converted into an acceleration of the rotor.

14. The method according to claim 13, comprising:
determining an aerodynamic tower vibratory output or an aerodynamic tower vibratory moment; and
correcting the rotor acceleration output while using the aerodynamic tower vibratory output or the aerodynamic tower vibratory moment.

15. The method according to claim 14, wherein determining the aerodynamic tower vibratory output or the aerodynamic tower vibratory moment includes:
determining an absolute wind speed in a region of the wind power installation;
determining a net wind output on the rotor based on the absolute wind speed;
determining an apparent wind output or an apparent wind moment, respectively, on the rotor based on a speed of a tower head and/or of a nacelle of the wind power installation; and
determining the aerodynamic tower vibratory output or the aerodynamic tower vibratory moment based on a difference between the apparent wind output and the net wind output.

16. The method according to claim 15, wherein the absolute wind speed is not influenced by the speed of the tower head and corresponds to a wind speed determined in the region of the wind power installation minus the speed of the tower head and/or of the nacelle of the wind power installation.

17. The method according to claim 15, wherein an output or a moment of the rotor is corrected by the aerodynamic tower vibratory output or the tower vibratory moment, respectively, as multiplied by a factor, wherein the factor is between 0.5 and 5.

18. The method according to claim 1, wherein the closed-loop rotating speed control is configured to control the wind power installation in at least one predefinable rotating speed range of a partial-load operating range and/or in a transition range from the partial-load operating range to a full-load operating range to the target rotating speed by superimposing a closed-loop rotating speed output control and a closed-loop pitch control,
the rotating speed in the case of the closed-loop pitch control is closed-loop controlled to the target rotating speed by adjusting the rotor status variable, and
the rotating speed in the case of the closed-loop rotating speed output control is closed-loop controlled by adjusting a generator status variable to be adjusted.

19. The method according to claim 1, wherein the rotor status variable is a pitch angle of the rotor.

20. The method according to claim 18, wherein the generator status variable is a generator output or a generator moment.

21. The method according to claim 18, wherein:
the transition range in the partial-load operating range is in an upper rotating speed range that is characterized by rotating speeds exceeding a transitional rotating speed, wherein the upper rotating speed range is above a rotating speed avoidance range, and
the wind power installation is characterized by a nominal rotating speed, and the transitional rotating speed is at least 80% of the nominal rotating speed and/or a target rotating speed of the closed-loop pitch control.

22. The method according to claim 18, wherein:
for the closed-loop rotating speed output control the target rotating speed is predefined using a transitional rotating speed characteristic curve, and
for a rotating speed having a rotating speed value corresponding to the transitional rotating speed the transitional rotating speed characteristic curve is vertical so that the rotating speed is constant as the generator status variable increases until the generator status variable reaches a predetermined first generator reference value which is below a nominal value of the generator status variable, and/or the transitional rotating speed characteristic curve from the transitional rotating speed and/or from the first generator reference value has a positive gradient so that the values of the generator status variable increase as the rotating speed increases until a nominal value of the generator status variable is reached.

23. The method according to claim 18, wherein the second control error is transmitted from the closed-loop rotating speed output control to the closed-loop pitch control, and the closed-loop rotating speed output control and the closed-loop pitch control operate at least partially in parallel and are mutually configured using the second control error, and/or a switchover or a transition between the closed-loop rotating speed output control and the closed-loop pitch control takes places as a function of the second control error.

24. The method according to claim 18, wherein the closed-loop rotating speed output control is prioritized in relation to the closed-loop pitch control such that the closed-loop pitch control is completely or partially suppressed as long as the closed-loop rotating speed output control does not reach an actuating variable limitation, and/or the closed-loop pitch control additionally controls the rotating speed as a function of an acceleration actual value of the rotor, and control of the rotating speed by the closed-loop pitch control is increasingly suppressed the greater a difference between a generator target value in the closed-loop rotating speed output control and a generator target value limit.

25. A closed-loop controller for a wind power installation,
wherein the wind power installation includes:
an aerodynamic rotor which is operable at a variable rotating speed and which has rotor blades that have blade angles that are adjustable, and
wherein the closed-loop controller is configured to:
perform, in at least one operating range of the wind power installation, closed-loop control, the closed-loop control including a closed-loop rotating speed control; and
perform the closed-loop rotating speed control on the rotating speed, the closed-loop rotating speed control including:
in response to the wind power installation not yet operating at a target output or a target moment, obtaining a reserve value based on a comparison of the target output or the target moment of the wind power installation and a momentary output or a momentary moment of the wind power installation, respectively;
adjusting a rotor status variable of the rotor blades based on the reserve value; and
controlling the rotating speed to become a target rotating speed based on adjusting the rotor status variable.

26. The controller according to claim 25, wherein the controller is configured to:
determine a first control error of the rotor based on a comparison of a predefined target rotating speed with and a detected actual rotating speed;
correct the first control error using the reserve value to obtain a second control error; and
determine a pitch angle or a pitch rate for adjusting the rotor status variable from the second control error.

27. A wind power installation, comprising:
the controller according to claim 25.

28. A wind farm, comprising:
a plurality of wind power installations including the wind power installation according to claim 27.
